(19) United States
(12) Patent Application Publication
(10) Pub. No.: US 2013/0046683 A1
(43) Pub. Date: Feb. 21, 2013

(54) SYSTEMS AND METHODS FOR MONITORING AND ENFORCING COMPLIANCE WITH RULES AND REGULATIONS IN LEAD GENERATION

(71) Applicants: Bruce Wayne Onder, Longbranch, WA (US); Tammy I-Chen Yao, Mountain View, CA (US)

(72) Inventors: Bruce Wayne Onder, Longbranch, WA (US); Tammy I-Chen Yao, Mountain View, CA (US)

(73) Assignee: ACADEMIXDIRECT, INC., Mountain View, CA (US)

(21) Appl. No.: 13/588,998

(22) Filed: Aug. 17, 2012

Related U.S. Application Data
(60) Provisional application No. 61/525,110, filed on Aug. 18, 2011.
(60) Provisional application No. 61/525,130, filed on Aug. 18, 2011.
(60) Provisional application No. 61/525,132, filed on Aug. 18, 2011.
(60) Provisional application No. 61/525,135, filed on Aug. 18, 2011.
(60) Provisional application No. 61/525,139, filed on Aug. 18, 2011.

(51) Int. Cl. G06Q 99/00; G06Q 20/22

(52) U.S. Cl. 705/39; 705/317

(57) ABSTRACT

Systems and methods are provided to generate leads for an organization that comply with the organizations rules and regulations. Leads originate from a network of marketing partners of a leads generating service. The web assets of the marketing partners are periodically, or continuously, monitored to insure that such web assets have required content and/or do not contain objectionable content. Over time, marketing partners who are consistently comply with an organizations rules and regulations earn the status of trusted marketing partners and leads originating from such partners are highly valued.

### CROSS-REFERENCE TO RELATED APPLICATION

This application claims priority under 35 U.S.C. §119(e) to U.S. Provisional Patent Application Ser. No. 61/525,110, filed on Aug. 18, 2011 (AXDI-P02-PRV); U.S. Provisional Patent Application Ser. No. 61/525,130, filed Aug. 18, 2011 (AXDI-P03-PRV); U.S. Provisional Patent Application Ser. No. 61/525,132, filed Aug. 18, 2011 (ADXI-P04-PRV); U.S. Provisional Patent Application Ser. No. 61/525,135 filed Aug. 18, 2011 (ADXI-P05-PRV); U.S. Provisional Patent Application Ser. No. 61/525,139, filed Aug. 18, 2011 (ADXI-P06-PRV); and U.S. Provisional Patent Application Ser. No. 61/525,144, filed Aug. 18, 2011 (ADXI-P07-PRV). The subject matter of all of the foregoing is incorporated herein by reference in their entirety.

### BACKGROUND OF THE DISCLOSURE

1. Field

This present disclosure relates generally to automated generation of leads from web-based advertisements.

2. Description of the Related Art

Businesses and other organizations, for example, non-profit educational institutions, often conduct business via websites. The traffic of such websites can be significantly increased by receiving leads from other websites. For example, links to an organization's website could be presented in various forms in search results or on a webpage of a provider of online content. Commonly, organization receiving leads from another organization's website will provide some form of compensation to such other organizations, for example, on a per impression basis or a per action basis.

An organization may also choose, additionally or alternatively, to receive leads via a lead management and generation service. In some cases, such services may be associated with a network of marketing partners. Organizations who wish to receive leads via a lead management and generation service typically enroll as a client of the lead management and generation service, and the service in turn places links and/or advertisements on behalf of the client with suitable marketing partners.

### BRIEF DESCRIPTION OF THE DRAWINGS

The following description and drawings are illustrative and are not to be construed as limiting. Numerous specific details are described to provide a thorough understanding. However, in certain instances, well-known or conventional details are not described in order to avoid obscuring the description. References to one or an embodiment in the present disclosure are not necessarily references to the same embodiment; and, such references mean at least one.

FIG. 1 shows a computer system 100, according to one aspect of the system and method described herein.

FIG. 2 shows 1 is a schematic diagram illustrating an exemplary embodiment of a network 222 within which the systems and methods disclosed herein could be implemented.

FIG. 3 shows a view of an exemplary screen 300, according to one aspect of the systems and methods disclosed here. Web page 300 includes an advertisement 301 relating to an advertiser (client), for example, an institution of higher education.

FIG. 4 shows an embodiment of the path 400 along which a web asset of a company may move when it becomes a marketing partner of a leads generating entity as disclosed herein.

FIG. 5 shows an exemplary process 500 for tracking the compliance of marketing partners of in a leads generating service, according to one aspect of the system and method disclosed herein.

FIG. 6 shows an exemplary process 600 for the treatment of noncompliant content or absence of required content by a leads generating service, according to one aspect of the system and method disclosed herein.

FIG. 7 shows an exemplary process 700 for acquiring brand-monitoring data, according to one aspect of the system and method disclosed herein.

FIG. 8 shows an exemplary process 800 of a system for examining brand data and ensuring compliance with branding standards, according to one aspect of the system and method disclosed herein.

FIG. 9 shows an overview of an exemplary system for assessing and validating leads 900, according to one aspect of the system and method disclosed herein.

FIG. 10 shows a detailed view of an exemplary lead validation process 1000, according to one aspect of the system and method disclosed herein.

FIG. 11 shows an overview of an exemplary network 1100 within which systems and methods for scheduling and conducting interviews could be implemented, according to one aspect of the system and method disclosed herein.

FIG. 12 shows an overview of an exemplary process 1200 for scheduling and conducting interviews, according to one aspect of the system and method disclosed herein. In step 1201 an online scheduler is invoked at the end of the process of filling out an online application form, as described above and throughout.

FIG. 13 shows an overview of an exemplary scheduling screen 1300.

FIG. 14 shows an over view of an exemplary system 1400 for strategically ranking and allocating results of web-based inquiries, according to one aspect of the system and method disclosed herein.

FIG. 15 show an exemplary process 1500 for strategically ranking and allocating results of web-based inquiries according to one aspect of the system and method disclosed herein.

FIG. 16 shows an exemplary process 1600 for treatment of a call from a lead call-in to a call center, according to one aspect of the system and method disclosed herein.

FIG. 17 shows an overview of an exemplary system 1700 for enhanced express and custom leads according to one aspect of the system and method disclosed herein.

FIG. 18 shows an exemplary process 1800 for partners to enter search requirements for candidates, according to one aspect of the system and method disclosed herein.

FIG. 19 shows an exemplary process 1900 of the program 716, described in the discussion of FIG. 17, for routing search engine users, according to one aspect of the system and method disclosed herein.

The figures depict embodiments of the present disclosure for purposes of illustration only. One skilled in the art will readily recognize from the following discussion that alternative embodiments of the structures and methods illustrated herein may be employed without departing from the principles of the present disclosure described herein.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Various embodiments of the systems and methods disclosed herein provide a leads management and generation service. In an embodiment, the leads generating service is provided by a leads generating entity that is partnered with a network of marketing partners. In an embodiment, client organizations enroll with the leads management and generation service and the service, in turn places links and/or advertisements relating to the client organizations with one or more of the leads generating entity's marketing partners. In various embodiments, clients pay fee for leads, for example, per lead or based on a subscription. In various embodiments, clients may bid against one another to receive leads.

In various embodiments, the leads management and generation service additionally provides enhanced services. Such enhanced services could include services that:
Lets a lead generation entity verify that contextual presentation of leads is done in a way that matches clients' specifications.
Provides brand monitoring to ensure that the quality, value, and appearance of a client's brand is maintained or improved.
Validates incoming leads and assesses how realistic these leads are, for example, determining whether a lead is likely the result of a prank or a mistake or if, in fact, the lead is generated for a real, valid candidate.
Provides a highly automated follow-up of a lead, where leads may be asked additional questions and in some cases may obtain guidance for investigating various options. Based on the outcome of the follow-up, the target organization can decide whether and how to further pursue the lead.
Enables a lead generator to present multiple interview results to leads, such as, for example, four schools, two of which have additional follow-up interview questions.
Analyze voice interactions between call-center agents and callers, either in real time or from recordings, and compare said analyzed material to sets of rules to verify that the caller has been treated correctly, in compliance with existing laws and/or relevant organization policies.
Transfers leads to partner sites, with the site selection based on each lead being evaluated for certain criteria where, rather than trying to optimize the quality of the candidate, the quantity is managed in an inexpensive way, thus enabling less expensive delivery of candidates.

### Overview of an Exemplary System

Exemplary systems and methods providing leads management and generation services are described immediately below. It should be understood that the systems and methods described are purely illustrative, and are not intended to be limiting. In the examples discussed below, client organizations are educational institutions seeking new students, however, the disclosed systems and methods are equally applicable to any other type of organization seeking leads to potential business. Thus, in the content of the present disclosure, the term “educational institution” should be understood to be interchangeable with the terms “client” and “client organization”, and the term “potential student” should be understood to be interchangeable with the term “lead”.

In an embodiment, the systems and methods disclosed herein comprise a network of web sites or web properties (also referred to herein as web assets) connected to a leads generating service. Each of the web assets may be controlled by the leads generating entity provided by the leads generating service and/or those controlled by marketing partners of the leads generating entity. In an embodiment, web sites or web properties are graded on a spectrum of compliance with leads generating policies of a leads generating entity and/or clients of the leads generating entity. For example, such grades could span the spectrum from “Unknown” to “Fully Compliant.”

In an embodiment, the leads generating entity's marketing partner promote clients' opportunities and/or services, using content that attracts potential website visitors, for example, potential students. In an embodiment, to ensure that website visitors are provided information relating to clients' opportunities and/or services, such information is provided in a context that meets client guidelines required by clients. In an embodiment, a web page including information relating to clients' opportunities and/or services is also equipped with a compliance tracking device, such as, for example, without limitation, a widget or a script.

In an embodiment, the tracking device can establish the compliance level used to drive the web site visitors. In an embodiment, visitors who arrive at a client's web page via a marketing partner's web page/web asset without a compliance tracking device are tagged with the lowest possible level of compliance, while those who arrive from a web asset with a tracking device and have been cleared as compliant by the leads generating entity can be scored higher based on the known reputation of the referring site and the marketing messages that were used to bring website visitors to that site. The system can provide a compliance score attribute for each website visitor that can have several values indicating levels of compliance (low/med/high, bronze/silver/gold, etc.) enabling a lead generation entity to assess not just a compliance level, but a confidence level for the compliance.

All marketing campaigns are associated with one or more web assets. For example, marketing partner Web Partner Co. uses its web asset, WebPartnerCoXYZ.com to drive traffic to the leads generating entity's website. Preferably, in this example, both sites are fully compliant with system guidelines, so leads generated from this partnership can score highly from a compliance standpoint. In some cases, the system may use a “weakest link” scoring rule when dealing with compliance, particularly if spread across many web sites, as is quite often the case. In these cases, the lowest score in the chain of web assets is the one the system uses to assess a marketing partner's compliance status. Generally this approach ensures that all compliance blocks are properly respected.

In an embodiment, the leads generating service reviews and approve web assets before they can be a known component of the network of assets utilized by the leads generating service. In an embodiment, this process involves at least three elements:
1. In an embodiment, the first element is an automated “crawling” of every asset, looking for non-compliant and required phrases. In an embodiment, if such non-compliant phrases are found, or required phrases are not found, the leads generating service sends notifications to a compliance manager (typically an employee of the leads generating entity) to review and decide on any follow-up actions that need to be taken (request content changes, end the partnership, et cetera). The service can compile historical data, enabling compliance manager to substantiate claims of compliance. In an embodiment, the compliance manager can request the system do a re-evaluation of properties once compliance issues have been claimed to have been addressed. In some cases, OCR (Optical Character Recognition) is applied to images in order to detect “hidden” disallowed messages or keywords. In an embodiment, clients can train partners and provide the compliance monitoring rules (compliance or required phrases and or keywords in combination and in some cases brand monitoring)
2. In an embodiment, the second element is categorization by the system of web asset content or properties into themes. In an embodiment, if a client requires the blocking of a specific theme, (as provided in the compliance monitoring rules above) the leads generating service automatically blocks it.
3. In an embodiment, the third element is a manual review of every web asset, based, for example, on data provided by the leads generating service. In an embodiment, the leads generating service notifies the compliance manager when a property requires manual review. Manual reviews are in addition to compliance validation notifications.

In an embodiment, the leads generating service system also provides the compliance manager a way to create compliance reviews and approvals (typically as memos or messages) that are communicated to marketing partners. Compliance issues may prevent the sale of leads from non-complaint marketing partners to certain end clients, thus reducing the marketing partner's overall value. Once compliance issues are resolved, leads can again be sold to those end clients, restoring the lost value.

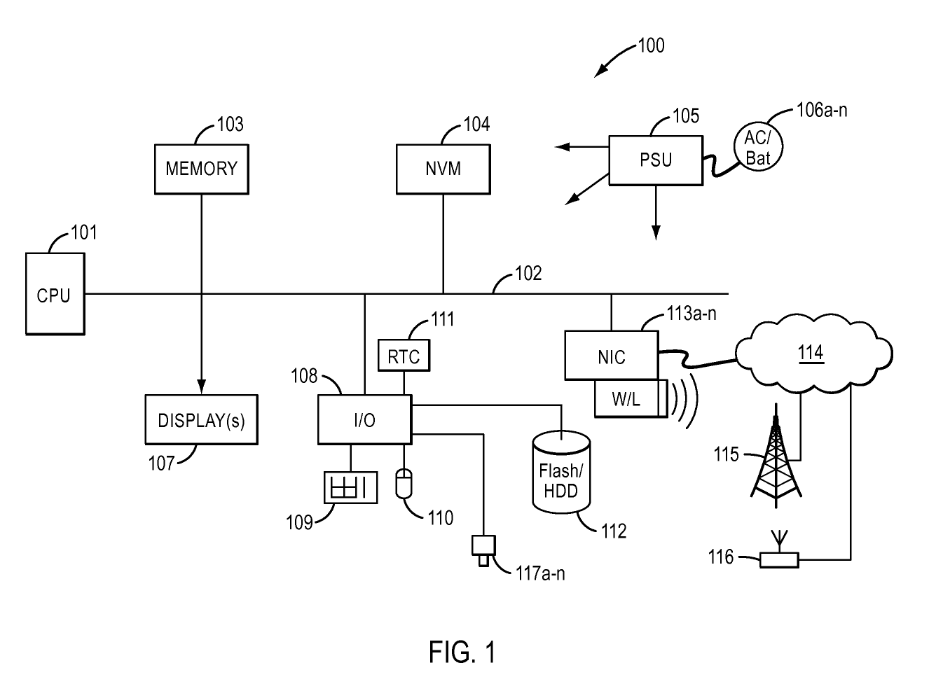

FIG. 1 shows a computer system 100, according to one aspect of the system and method described herein. Computer system 100 is exemplary of any computer that may execute code to process data. Various modifications and changes may be made to computer system 100 without departing from the broader spirit and scope of the system and method disclosed herein. In various embodiments, the leads generating service may be implemented, in whole or in part, using servers and/or other computing devices having architecture similar to that shown in FIG. 1. In various embodiments, various web assets within the leads generating service's network may be implemented, in whole or in part, using servers and/or other computing devices having architecture similar to that shown in FIG. 1.

CPU 101 is connected to bus 102, to which bus is also connected to memory 103, nonvolatile memory 104, display 107, I/O unit 108, and network interface card (NIC) 113. I/O unit 108 may, typically, be connected to an input device 109, such as a keyboard, a touch screen, buttons, etc, mouse or any other suitable graphical input device 110, hard disk (or in some cases other suitable storage, including, but not limited to solid state disk, RAID, network attached storage, storage area network, portable storage, etc.) 112, one or more cameras 117a-n, and real-time clock 111.

One or more network cards/interfaces 113a-n, some of which may be wireless, may connect to WANs 115 or wireless LANs 116, all of which are connected via Internet 114. Also shown as part of system 100 is power supply unit 105 connected, in this example, to AC supply 106. Not shown are batteries that could be present, and many other devices, including but not limited to special enhanced pointing or navigational devices, such as mice, jog wheels, microphone(s) and speaker(s) and/or headset(s) for recording and or playing back audio, and other modifications that are well known to those skilled in the art that could potentially enhance the operation of the systems and methods disclosed herein.

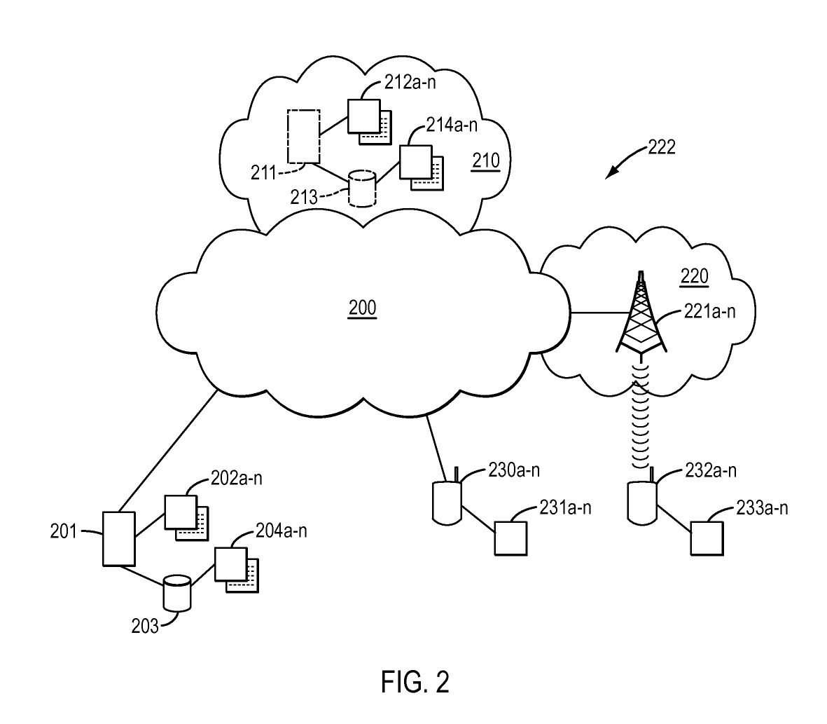

FIG. 2 shows 1 is a schematic diagram illustrating an exemplary embodiment of a network 222 within which the systems and methods disclosed herein could be implemented. At the center of the network 222 is the Internet 200, shown as a cloud. Server 201 (lower left) has programs 202a-n and storage unit 203, which storage includes objects 204a-n. In an embodiment, server 201 has architecture similar or identical to the computer system 100 of FIG. 1. In various other embodiments, depending on the configuration of system 222, that system may include multiple servers and/or multiple storage units, or it may be connected to a network of storage units, or the system may be configured in other ways that provide similar functionality.

In other cases, rather than having a physical server at a physical site of a marketing partner, the system may include virtual servers in a so-called “cloud” 210. (Such cloud services are available from various vendors, including, but not limited to, Amazon, Microsoft, Bell, HP, IBM, and others, as well as many smaller vendors.) One or more virtual servers 211 are present in cloud 210. Servers 210 have programs 212a-n and also one or more virtual storage units 213, which storage units include objects 214a-n. To a user device, such as computer system 100, accessing a server, there are no detectable differences when accessing one or more physical servers located at a physical site, one or more virtual servers in a cloud, or a combination of the two.

Many types of server access are available through co-location, shared servers, dedicated servers, and other variations of service. In an embodiment, the computer system 222, the virtual servers 211, or a combination of both, implement a leads generating service as disclosed herein. In an embodiment, the computer system 222, the virtual servers 211, or a combination of both, implement web assets of a leads generating service and/or web assets of marketing partners of a leads generating entity.

User devices 230a-n, which are exemplary of many types of user devices such as computer system 100, include software code 231a-n. In some cases, additional local storage may be present, which storage may include local objects as well. Wireless network 220 with towers 221a-n may be representative of any type of wide-area network (WAN), including but not limited to 2G, 2.5G, 2.75G, 3G, 4G, 5G, or any similar type. Independent of the technology, network 220 enables mobile computing devices (for example, smart phones, tablets, etc.) such as 232a-n to connect through the wireless system through Internet 200 and thence to servers such as servers 201 and 211. Devices 232a-n may include software code 233a-n, as well as storage units and stored objects, not shown. In an embodiment, one or more 230a-n of user devices have architecture similar or identical to the computer system 100 of FIG. 1.

### Monitoring and Enforcing Compliance with Rules and Regulations

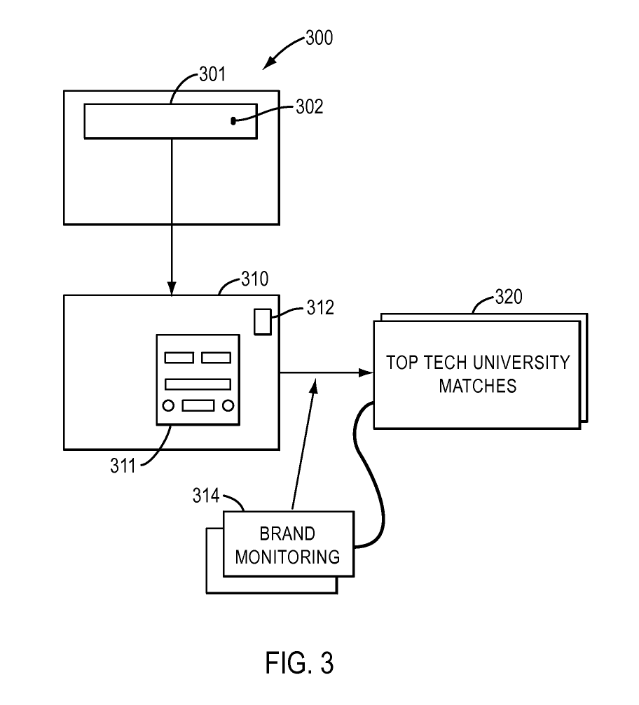

FIG. 3 shows a view of an exemplary screen 300, according to one aspect of the systems and methods disclosed here. Web page 300 includes an advertisement 301 relating to an advertiser (client), for example, an institution of higher education. In various other embodiments, the marketing can be done through other means (including but not limited to paid search, display ads, or other suitable ads, emails, etc., all considered variants of ad 301). In an embodiment, the advertisement can include one or more components including, without limitation, one or more images, one or more scripts, and/or a hyperlink directed to a leads generating service (serving as an intermediary for the advertiser). In an embodiment, the advertisement 301 is presented by or on behalf of a marketing partner of a leads generating entity. In an embodiment, the advertisement 301 and/or one or more of its components are requested by the webpage 300 from the leads generating service pursuant to an advertising opportunity.

In an embodiment, the leads generating service tracks the compliance of the advertisement 301, the webpage 300 and/or the website for compliance with rules and regulations specified by the client organization referenced in the advertisement 301 and/or rules and regulations of the leads generating entity. In an embodiment, such tracking utilizes the ability of the requested image or script to know the requesting URL, for example, by using functions available in the browser session cache or similar, or in other cases, by looking up the IP address making the request, enabling the leads generating service to record the URL requesting the advertisement. The leads generating service can then immediately screen-scrape the entire site of such URL to find the actual marketing message.

Additionally or alternatively, a compliance tracking device 302, for example, a script or a widget, can be embedded in the advertisement 301 that monitors the webpage 300 content in and around the advertisement 301 (in an embodiment, all of Web page 300). The compliance tracking device 302 can gather additional information including the URL displaying the advertisement and an identification of user the viewing the advertisement. This information can then be provided to a compliance server (for example, software instance 202c in server(s) 201, or any other suitable device) within the leads generating service. In an embodiment, information gathered by the compliance tracking device 302 and/or servers within the leads generating service can be consolidated and reported, enabling the original content disseminator to track where that advertisement has been viewed, by what website visitor, and in what context it was presented to the user.

In the example illustrated in FIG. 3, a website visitor that selects the advertisement 301 is then routed to a lead generation website 310 for an institution of higher education (i.e. the client advertiser). In an embodiment, the lead generating website 310 is used to, inter alia, gather additional information from the visitor to determine if the visitor is a qualified lead (e.g. qualified to apply for admission). In an embodiment, the leads generating website 310 is hosted by the institution of higher learning. In an embodiment, the leads generating website 310 is hosted by the leads generating service. In an embodiment, the leads generating website 310 is hosted by a third-party, for example, a marketing partner.

In an embodiment, the visitor is presented with a lead-in form 311. The lead-in form 311 may have some simple questions regarding the website visitor's qualifications, but such questions are typically kept to a minimum to avoid discouraging submission. In an embodiment, another compliance tracking device 312 helps monitor the content on webpage 310 around the lead form 311, by providing a compliance server (for example, software instance 202c in server(s) 201, or any other suitable device) to obtain the URL of the page on which the tracking device is used and screen scrape its content for analyzing compliance with applicable rules and regulations.

Based on the visitor's responses to the lead form 311, as well as the level of compliance achieved by the webpages 300, and 310, the website visitor interested in admittance to the institution of higher education is then sent on to a landing page 320 for the client, in the illustrated embodiment an information request form for TopTech University. In various embodiments, the landing page 320 may have additional questions regarding visitor's qualifications required by the client, such as, in this example, TopTech University. In an embodiment, the landing page 320 is hosted by the institution of higher learning. In an embodiment, the landing page 320 is hosted by the leads generating service. In an embodiment, the landing page 320 is hosted by a third-party.

It is clear, that the actual configuration and sequence may be altered without departing from the broader spirit and scope of the examples cited here. For example, all web pages may run on one server, or several servers, may be owned by one entity or several entities, or may be “one page” with a sequence of content etc.

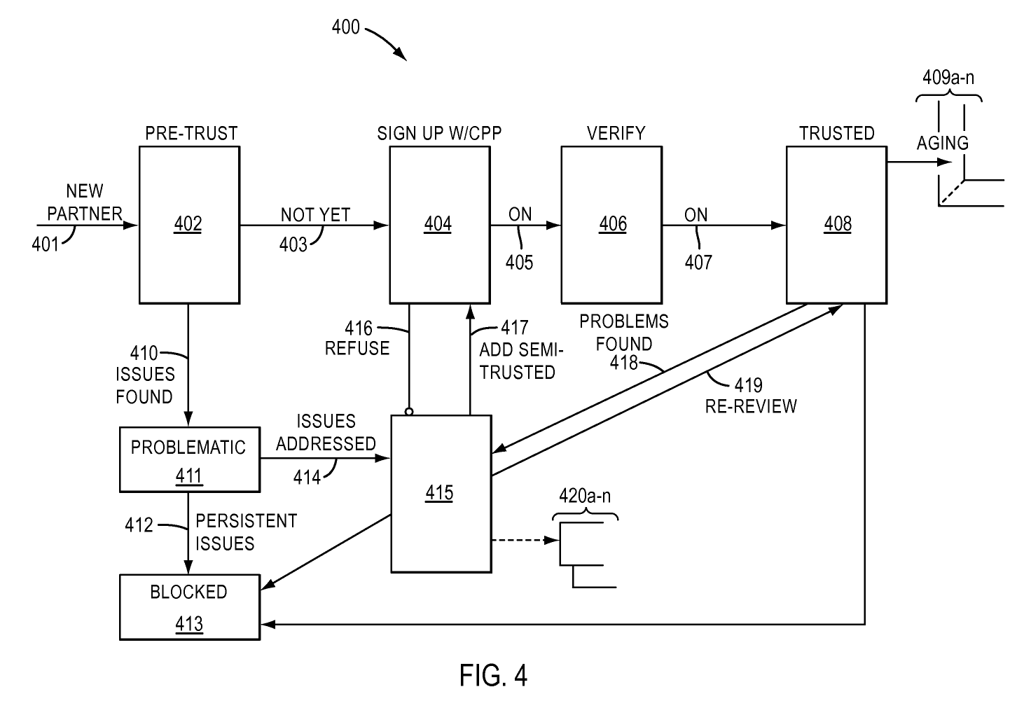

FIG. 4 shows an embodiment of the path 400 along which a web asset of a company may move when it becomes a marketing partner of a leads generating entity as disclosed herein. An applicant for partnership 401 (a company that wants to become a marketing partner) comes in from the left. Applicant 401 is placed in a pre-trust status 402. From there, the applicant may progress along path segment 403 to path point 404, where the applicant signs up for the compliance tracking device program of the system and method described herein, which program places compliance tracking devices, such as tracking device 302, described previously in the discussion of FIG. 3, in an advertisement or other web asset of the applicant 401.

Alternatively, in an embodiment, the applicant 401 first submits its web assets, including websites, marketing materials, and placements for review by the leads generating service. In an embodiment, if, while applicant 401 is in pre-trust status 402, the service finds issues (for example, blacklisted words used in content information on the same web asset), applicant 401 is routed from status 402 along path segment 410 to a problematic status 411. If such issues persist and cannot be resolved, applicant 401 is blocked, at path point 413, from becoming a partner. If such issues are resolved, the applicant moves along path segment 414 to semi-trusted status 415, and from there along path segment 417, to point 404, where the applicant may sign up for the compliance tracking device program of the service.

In an embodiment, when an applicant signs up for the compliance tracking device program of the service at point 404 and adds a compliance tracking device to its web assets, it moves along path segment 405 to verification status 406, and, after a predetermined number of successful uses, on through segment 407 to trusted status 408. In an embodiment, if, after signing up, an applicant is discovered to be abusing the service by placing ads in a non-compliant context, or the applicant refuses to sign up for the compliance tracking device program, then the applicant is directed via path segment 416 back to semi-trusted status 415.

In an embodiment, any time the service finds a problem with a marketing partner or some of its web assets, the partner or those or web assets may be directed via path segment 418 (or other, similar paths, not shown) back to semi-trusted status 415, from which, after a review 419, a marketing partner or some of its web assets may return to trusted status 408. A marketing partner or some of its web assets may also move from trusted status 408 or semi-trusted status 415 to path point 413, where the marketing partner or some of its web assets are blocked.

In an embodiment, once a partner has been in trusted status 408 for a predetermined period or number of transactions, the marketing partner's status or the status of some of its web assets (jointly or separate) may age into any of various higher states 409a-n. In an embodiment, these higher states indicated higher status levels, similar to those of a gold status of an airline mileage program or other, similar premium status. For every (or a given number of) successful transaction, a partner or some of its web assets moves along the path, and for every achieved transaction milestone, the partner may earn a new status. In an embodiment, companies with higher status may be rewarded with better, higher-paying leads or other meaningful incentives. In an embodiment, better, potentially higher paying leads could comprise leads that have a high compliance rating. In an embodiment, better, potentially higher paying leads could comprise leads that originate from a source that is known to be source of reliable leads.

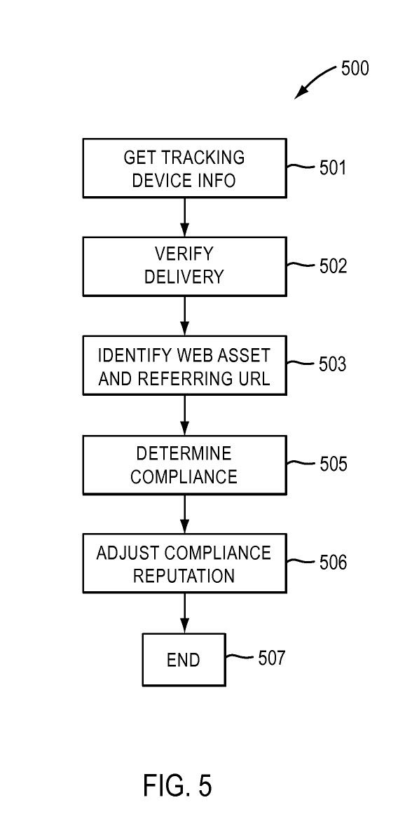

FIG. 5 shows an exemplary process 500 for tracking the compliance of marketing partners of in a leads generating service, according to one aspect of the system and method disclosed herein. In an embodiment, marketing partners are issued a compliance tracking device, which is to be placed on all web assets so that it is activated when the lead data collection process (for example, a form that posts to, or a hyperlink that transfers the website visitor to, the operator's web asset) begins.

In step 501, the tracking device is activated and the leads generating service receives the tracking signal. In step 502, the leads generating service uses data provided in the tracking signal to identify the web asset and the referring URL (typically the advertisement used to attract the visitor). In step 503 the leads generating service stores this data in the service's databases, In step 505 the leads generating service executes a verification procedure to determine the compliance level used to attract the visitor. In step 506, the marketing partner's compliance reputation (or that of some of its web assets) is adjusted based on the current compliance level and sets of rules provided by various clients of the generated lead, and in step 507, the process ends.

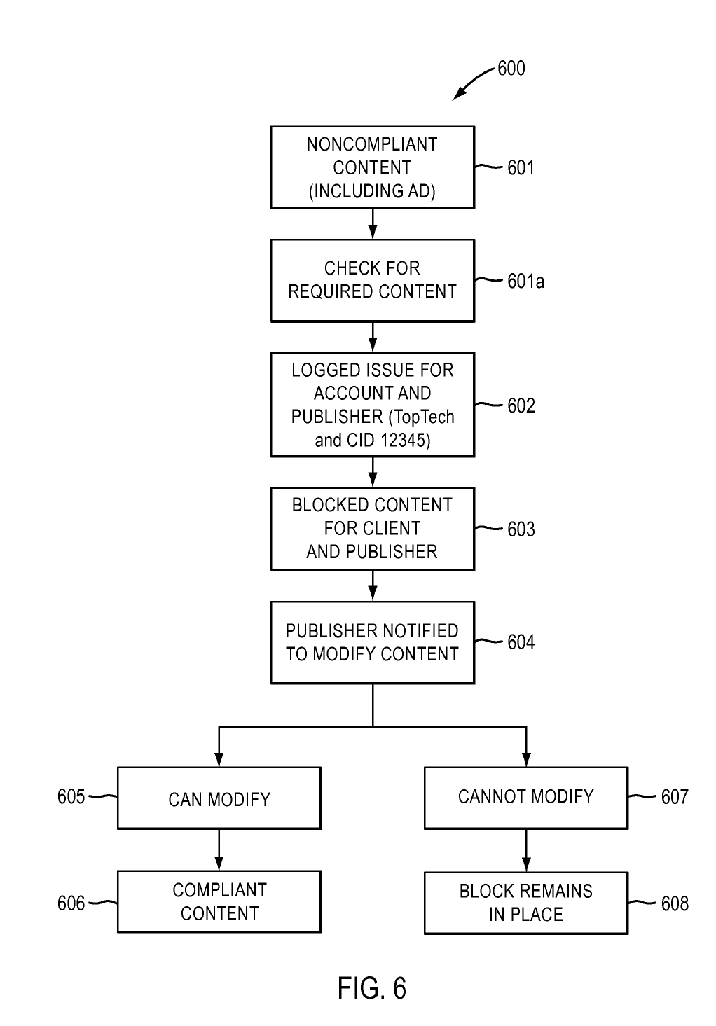

FIG. 6 shows an exemplary process 600 for the treatment of noncompliant content or absence of required content by a leads generating service, according to one aspect of the system and method disclosed herein. In step 601, the content, such as, for example, the content of advertisement 301, described in the discussion of FIG. 3, above, is tested and found to be noncompliant or missing required content. Then, further, in step 601a the content is tested to determine whether required content is present and in the correct format, size, resolution, etc. In step 602, the issue is logged for the marketing partner and the client, in this example, TopTech University, noting the page and the identity of the noncompliant content or missing required content.

At the same time, the website visitor is transferred to a page and or form of a client accepting a visitor, where that client's compliance rules do not object to that content or where the website visitor fulfills the requirements of required content for that client. For example, compliance rules may dictate that a user enter certain key words or key phrases into a clients form. In step 603, the marketing partner is blocked from sending leads to a client. In step 604 the marketing partner is notified of the noncompliant content or missing required content, with information about just what is noncompliant and how, if possible, to change the content to achieve compliance. The marketing partner, then, may elect, in step 605, to modify the noncompliant content or add the required content and notify the system. In step 606, the modified content is reviewed and, if compliance is achieved, the page is unblocked (not shown). Alternatively, the marketing partner may not, or may not be able to, modify the content. In this case, the visitors are offered forms and content of different clients that accept visitors where that client's compliance rules don't object to that content.

### Brand Monitoring in Marketing Campaigns

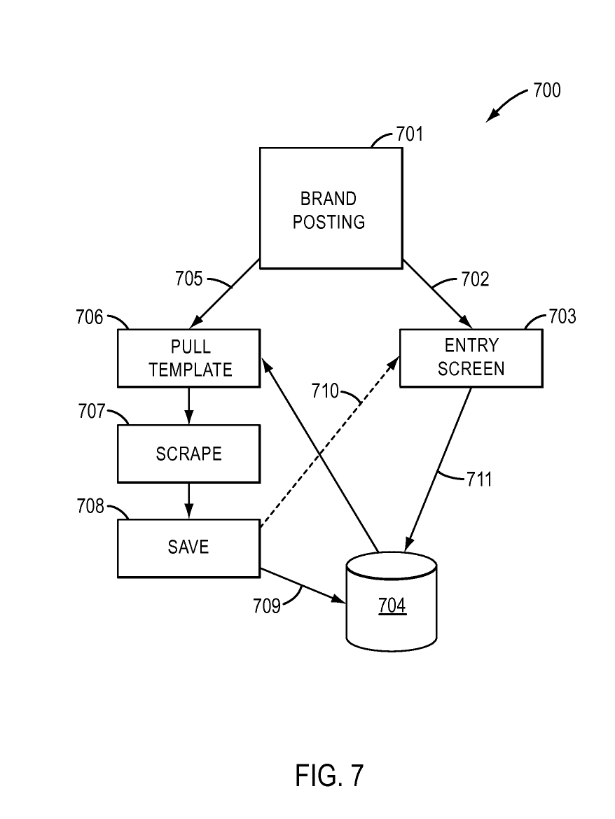

FIG. 7 shows an exemplary process 700 for acquiring brand-monitoring data, according to one aspect of the system and method disclosed herein. In step 701 a brand owner issues, in one of several ways, a new brand posting (BP). Sometimes the brand owner may simply send a letter to marketing campaign partners; other times the brand owner may send an email with an embedded link. And in some cases the information may be posted on a web message may be in the form of an email, with or without attachment and with or without site and updated on occasion as desired by the brand owner. In some cases, the new brand data may be manually entered via arrow 702 into a form in a data entry screen 703, where important information for monitoring a brand is entered.

Listed below are examples of the information useful for brand monitoring that could be entered in screen 703 (and stored in data base 704, below). Depending on the situations, some partners may have fewer items or additional items.

### 1. Originating Traffic.

a. Are the advertised programs currently offered by the school? (If not, could be considered “misrepresentation” by the US Dept. of Education.) E.g., does College XYZ offer a “Pharmacy Technician” program? Such information could be acquired, inter alia, manual brand posting, subject categories in a spreadsheet or harvested from a website.
b. Are the school brands, misspellings and trademarked terms set to negative? E.g., AxD should not bid on terms that include the company and branded names of the direct customers that are being marketed for lead generation purposes.
c. Filtering of ad engine to exclude negative terms for page.

### 2. Logo Usage Monitoring

On school form page (either service-provider or third-party-owned), is the most recent version (updated per latest BP) of the logo being used?
   a. Correct color code (HTML hex numbers)
   b. Correct resolution
   c. Correct size/placement
   d. Compliant copy, imagery, content

### 3. Form Posting Updates

On school form page, is their provider or third party content current on all the schools' requested updates?
   a. Routing to schools based on candidate ZIP code, for example ZIP code to specific school campus—candidate ZIP for campus (reaccredited, etc.)
   b. Programs/program descriptions
   c. School descriptions
   d. Form questions
   e. Required copy (e.g., Do Not Call/Do Not Email list, etc. w/checkbox)
   f. Privacy policy, other “copy” etc. (in some cases: send for approval)

After data is entered, it is saved in database 704, as indicated by arrow 711 in brand monitoring records comprising brand filters such as those described above. Database 704 may be in a separate data repository, or it may be in data repository 203. In other cases, when the new branding is issued on paper or on some other type of hard copy media, it can be scanned and processed electronically, so it becomes electronic copy, the same as branding information that is distributed or made available electronically in the first place.

In such cases, as indicated by arrow 705, in step 706 a pull template is loaded from database 704. This template typically is generated by a human. It enables the software to recognize different sections of electronic brand data and extract the relevant information. In step 707 the data is scraped from the template sections, and in step 708 the data is saved in database 704, as indicated by arrow 709. In some cases, as indicated by arrow 710, the scraped data may be sent to populate data entry screen 703 for further manual review. The reviewer can then manually compare the original brand posting with the scraped data in screen 703 to ensure that the new brand posting has been correctly processed. If the reviewer finds discrepancies between the BP and the pre-filled fields on the screen, indicating poor results in BP acquisition, the template may be modified to improve the quality of the scraping in the future.

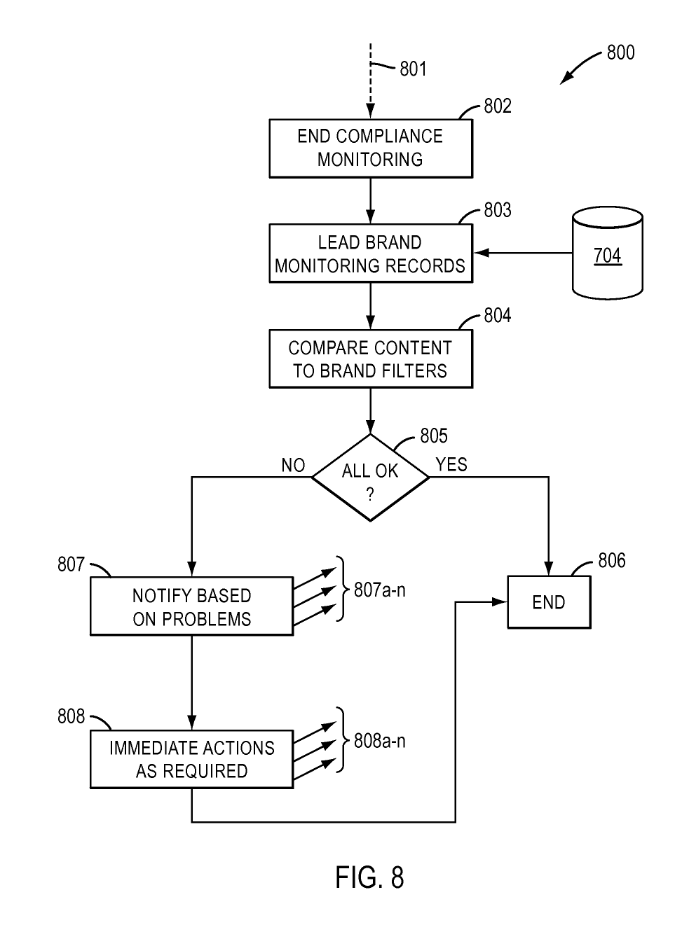

FIG. 8 shows an exemplary process 800 of a system for examining brand data and ensuring compliance with branding standards, according to one aspect of the system and method disclosed herein.

In an embodiment, after a web asset has been evaluated for compliance with a client's rules relating to noncompliant content and required content, as described above, compliance monitoring of the asset ends 802. In an embodiment, in step 803, the service then loads brand-monitoring records comprising one or more brand filters relating to one or more brands from database 704. In step 804, the content of the web asset is then evaluated using the brand filters loaded in step 803. Any and all items described above, as well as additional items not mentioned here, may be examined pursuant to the brand filters. For example, pixel resolution of brand images may be required to meet requirements, as well as the various specifications and criteria noted above.

In step 805, the process branches. If the examined web asset meets all standards (Y) embodied in the filters, the process terminates at step 806. If any examined web asset does not meets all standards (N) embodied in the filters, in step 807 the system sends notifications 807a-n to people, organizations, or entities charged with or allowing publishing of compliant brand information. Those notified could be internal staff or marketing partners.

In an embodiment, in some cases, brand owners may require that notification of improper brand use also be sent, as part of monitoring brand usage, so these messages could also be included in messages 807a-n. In step 808, depending on the type of non-compliance detected, immediate actions 808a-n may be required, such as, for example, turning off certain campaigns, discontinuing certain partnerships, or restarting the process of compliance certification for certain partners. After the actions required in step 808, the process terminates at step 806.

Note that in various embodiments, an entity on whose behalf a brand is monitored could be a separate entity from clients placing advertisements relating to the brand. For example, a client may place advertisements relating to a brand not owned or controlled by the client. The leads generating service evaluates the webpages upon which such advertisements are placed for compliance with the client's rules relating to noncompliant content and required content. The leads generating service then evaluates the webpages upon which the advertisements are placed, as well as, perhaps, the advertisements themselves for compliance with the brand owner's brand standards.

### Assessing and Validating Leads

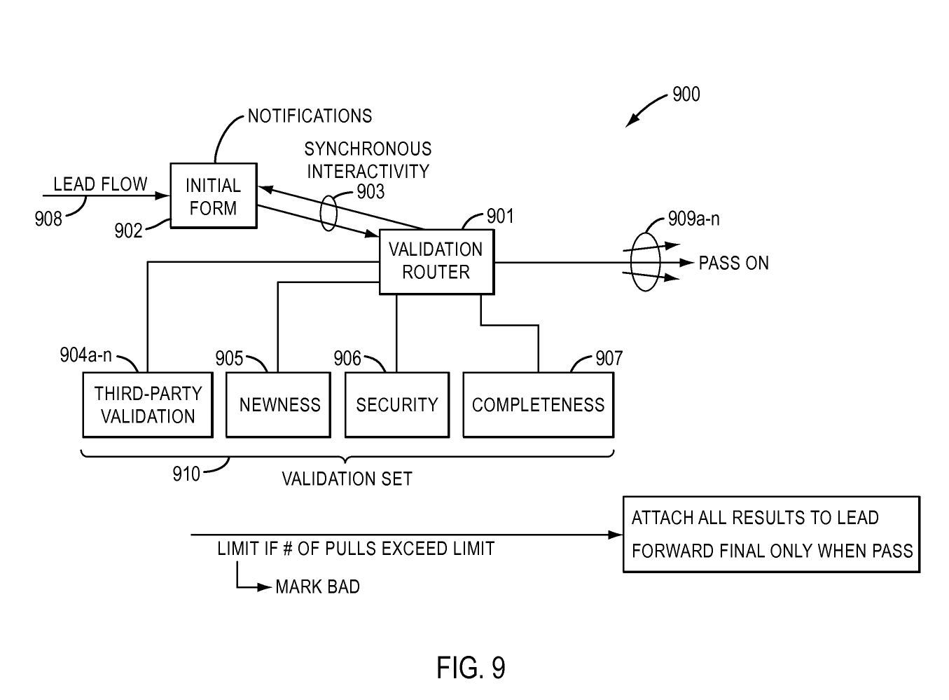

FIG. 9 shows an overview of an exemplary system for assessing and validating leads 900, according to one aspect of the system and method disclosed herein. When leads come in from various sources, as indicated by arrow 908, the lead flow comes to the initial form 902, which interacts in a synchronous way with validation router 901, for example, by using scripts or online forms that can interact proactively, as indicated by arrows 903. The interaction type is discussed further below. Validation router 901 runs the leads through one or more modules of validation set 910, depending on the nature of the lead.

Validation modules include third-party validation modules 904a-n (multiple of these modules can be concurrently active), newness check 905, security check 906, and completeness check 907. Third-party validation providers may include, but are not limited to, the following: TargusInfo (email verification, EDU score, address verification, phone verification), MelissaData (phone verification, address verification, email verification), CDYNE (phone verification, address verification; eBureau (EDU score), and TheatMetrix (fraud detection). Newness checks may include OnTarget (EDU score), fake names DB (identifies fake names), and Bad Words DB (identifies bad words). The system gives a score for each check.

However, if a user needs to fill in a form more than once because, for example, he has filled in a form incorrectly, additional pulls (synchronous queries to internal or external services of the validation router) may be required. Because of the costs involved with each pull, particularly with third-party validation providers, a user is restricted to a specific number of pulls on the checks, and when the allotted number of pulls is exhausted, the user is disqualified. This restriction on the number of pulls per form also quickly eliminates any frivolous or mischievous activity with the forms. Invalid forms are initially accepted but later in the process they are discarded.

After the validation checks by modules in validation set 910, validation router 901 creates a composite score value. In some cases, the score may be drawn from a check by only one module; in other cases, the score may be a weighted or otherwise calculated accumulation of scores from checks by multiple modules, both internal and external. From this score, the router can decide whether this lead is a qualified lead, a suspect lead, or an erroneous lead that should be discarded. Such lead classifications are indicated by arrows 909a-n.

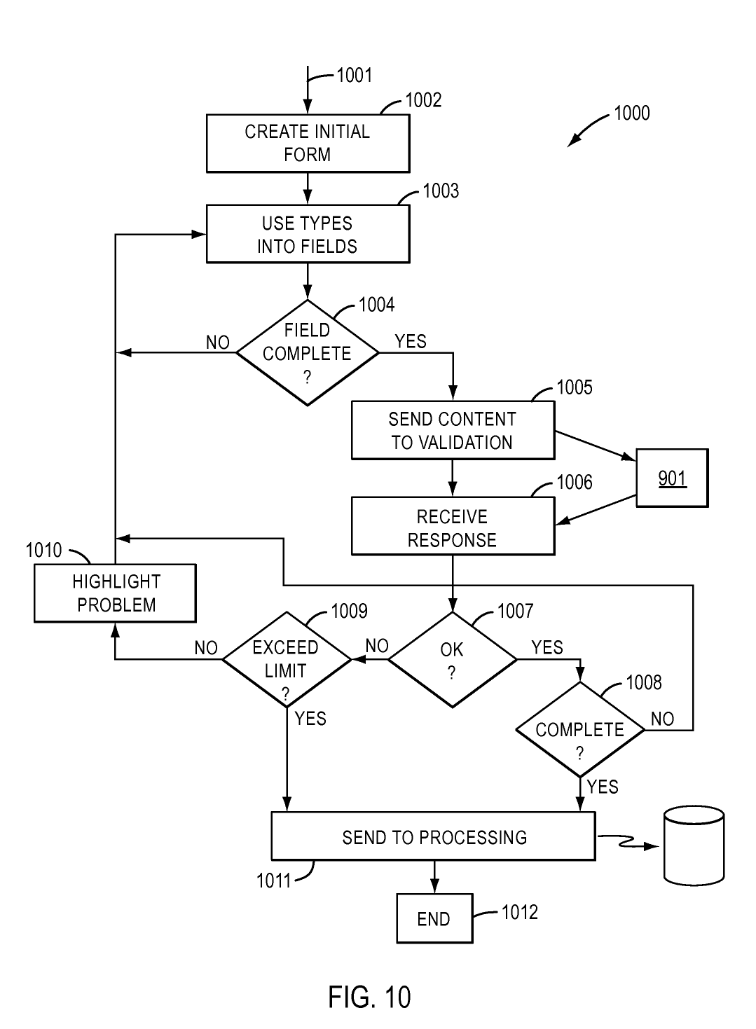

FIG. 10 shows a detailed view of an exemplary lead validation process 1000, according to one aspect of the system and method disclosed herein. In step 1001 leads comes into the system from lead generation sites and may be treated as discussed earlier and throughout. In step 1002, for each lead, an initial form is created for the school or other institution selected for presentation to the candidate. In step 1003, the user types information into the form fields. In some cases, the process may offer to fill in certain fields as the user enters text, in a manner similar to practices well known in the art of interactively offering field completions, using the most common past selections by users. In other cases, the system waits until the user finishes a field.

In step 1004 the system determines whether a field is complete (yes—user moves to next field in form) or not (no—user is still in present field), and when a field is complete, its contents are sent to validation router 901 in step 1005. In step 1006, the system receives a response from the validation router, which response is evaluated in step 1007. If the response is OK (yes), meaning that the score exceeds a pre-set value, in step 1008, the system checks to determine whether the form is complete. If the form is complete (yes), in step 1011 the data are sent to be processed in data repository 203 and the process ends in step 1012.

If, in step 1008, the system determines that the form is not complete, the process moves back to step 1004, and continues to cycle thus until the user completes the form. If, in step 1007, the validation router returns a response indicating that the score is not OK (no), meaning there is a problem with the content of the field under consideration, in step 1009, the system determines whether the number of checks for that field has exceeded its pre-set limit. If the number of checks is over the limit (yes), the data are sent to processing marked “invalid” and discarded upon processing, although the user receives a message that his form has been processed.

If, in step 1009, the system finds that the number of checks has not exceed the limit (no), in step 1010 the system highlights the problem in the form and cycles it back to user input in step 1003. Some types of problems, such as, for example, formatting of a phone number, may be corrected locally, that is, within the system, and thus do not cost money and may not be counted in the number of pulls allowed a candidate. However, other types of problem, such as, for example, verification of a phone number, require validation by a third-party provider, such as, for example, TargusInfo or some other provider or any others of those listed above. These latter types of problems cost money and are, therefore, subject to a limited number of retries, often only one or two, after which the form is accepted but not further processed.

### Virtual Interview Scheduler for Follow-Up Applications

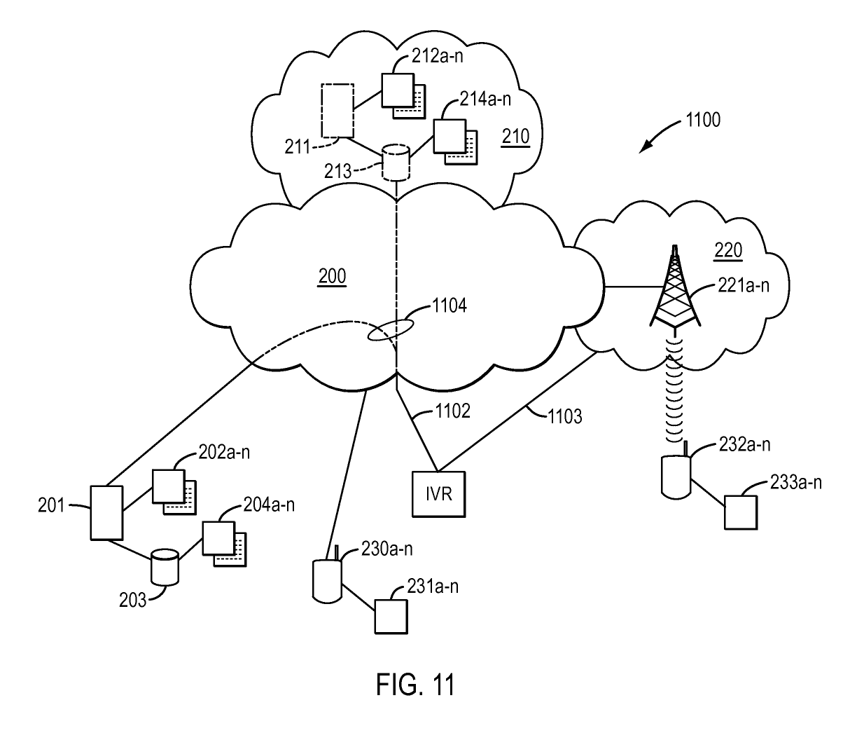

FIG. 11 shows an overview of an exemplary network 1100 within which systems and methods for scheduling and conducting interviews could be implemented, according to one aspect of the system and method disclosed herein. Network 1100 is based on network 222, shown in FIG. 2, above, has additional elements. At the center of the network 222 is the Internet 200, shown as a cloud. Server 201 (lower left) has programs 202a-n and storage unit 203, which storage includes objects 204a-n. In an embodiment, server 201 has architecture similar or identical to the computer system 100 of FIG. 1. In various other embodiments, depending on the configuration of system 222, that system may include multiple servers and/or multiple storage units, or it may be connected to a network of storage units, or the system may be configured in other ways that provide similar functionality.

In other cases, rather than having a physical server at a physical site of a marketing partner, the network may include virtual servers in a so-called “cloud” 210. (Such cloud services are available from various vendors, including, but not limited to, Amazon, Microsoft, Bell, HP, IBM, and others, as well as many smaller vendors.) One or more virtual servers 211 are present in cloud 210 Servers 210 have programs 212a-n and also one or more virtual storage units 213, which storage units include objects 214a-n. To a user device, such as computer system 100, accessing a server, there are no detectable differences when accessing one or more physical servers located at a physical site, one or more virtual servers in a cloud, or a combination of the two.

Many types of server access are available through co-location, shared servers, dedicated servers, and other variations of service. In an embodiment, the computer system 222, the virtual servers 211, or a combination of both, implement a leads generating service as disclosed herein. In an embodiment, the computer system 222, the virtual servers 211, or a combination of both, implement web assets of a leads generating service and/or web assets of marketing partners of a leads generating entity.

User devices 230a-n, which are exemplary of many types of user devices such as computer system 100, include software code 231a-n. In some cases, additional local storage may be present, which storage may include local objects as well. Wireless network 220 with towers 221a-n may be representative of any type of wide-area network (WAN), including but not limited to 2G, 2.5G, 2.75G, 3G, 4G, 5G, or any similar type. Independent of the technology, network 220 enables mobile computing devices (for example, smart phones, tablets, etc.) such as 232a-n to connect through the wireless system through Internet 200 and thence to servers such as servers 201 and 211. Devices 232a-n may include software code 233a-n, as well as storage units and stored objects, not shown. In an embodiment, one or more 230a-n of user devices have architecture similar or identical to the computer system 100 of FIG. 1.

Additionally shown in FIG. 11 is IVR 1101, which is connected to Internet 200 via data connection 1102 and also to telephone system 220 via connection 1103. In some cases the telephony connection may go through the Internet as well, using voice over Internet protocol (VOIP). Dotted lines 1104 are the control connections coming from either the physical operating center server 201 or the virtual client server 211. The IVR system 1101 may be owned and operated by the service operator, or it may be leased on a time-used basis or other arrangement from a third party as IVR cloud services or advanced VOIP services. Scripts for the IVR system may be preloaded from one of the servers into the IVR system, or they may be made available in real time.

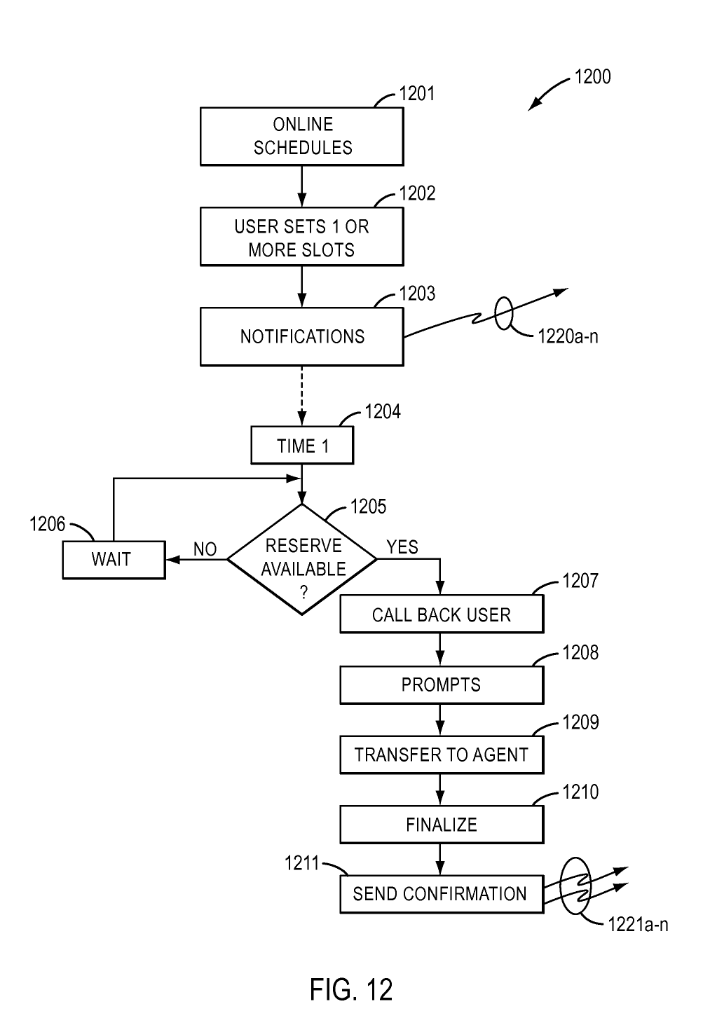

FIG. 12 shows an overview of an exemplary process 1200 for scheduling and conducting interviews, according to one aspect of the system and method disclosed herein. In step 1201 an online scheduler is invoked at the end of the process of filling out an online application form, as described above and throughout.

In step 1202 a user selects one or more time slots, depending on how the online scheduling calendar is configured, which subject is discussed in greater detail below. In step 1203 the system sends notifications to user in one or more forms, as indicated by one or more arrows 1220a-n. At Time 1 1204, the system checks in step 1205 to determine if a resource for a call (IVR system and/or human agent) is available. If a resource is available (yes), the process moves to step 1207; if no resources is available (no), the system waits in step 1206 for a predetermined period of time and then returns to step 1205 to check the availability of a resource again. This waiting period could be a randomized, predetermined period of time, or it could be an actual period based on scheduling expectations of freeing up resources.

In step 1207 the system calls the user, and in step 1208 the user is prompted through a series of questions by an interactive voice response (IVR) system. The user may respond to the questions by voice or by pressing keys. These questions and responses are preparatory for an actual interview with a human interviewer. After the questions are completed, in step 1209 the call may be transferred to a live agent by a call from the IVR system to the agent. The agent may be an employee of the system provider, or he may be a third-party employee under contract.

The IVR system itself also may be operated by the provider of the leads generating service, a client, a marketing partner, or a third party under contract. When the agent follows up the IVR system questions, using a provided script, as is typical for call center operations, the agent can finalize the call in step 1210 by taking additional information or by sending additional information to the user. In step 1211, final information, confirmation, and/or notifications are sent, as indicated by arrows 1221a-n, to all the concerned parties, such as the web user participating in the interview, provider-based and/or third-party call center, and/or the schools or other institutions participating in the campaign. In some cases, depending on the initial responses, instead of speaking with a live agent, the web user may be transferred to a recording of instructions and additional proposals.

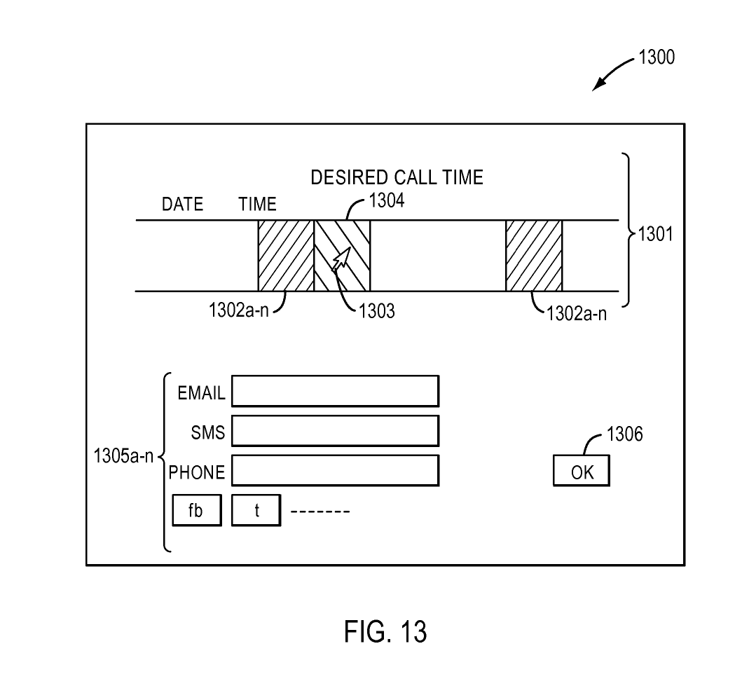

FIG. 13 shows an overview of an exemplary scheduling screen 1300. The scheduling calendar band 1301 displays periods of unavailable time slots 1302a-n. For example, these periods may be unavailable because agents are not present, or because all agents are already booked. User pointer 1303 is resting on time slot 1304, which the user has reserved by clicking on it. The selected date and time appear on the screen above the calendar band. The user can scroll the calendar left or right to find a suitable available time slot. Depending on the implementation of the calendar, the band may show only one day, or a week, or a month, or any predetermined time period.

The user may choose among notification methods 1305a-n, entering information such as, for example, email address, SMS or text phone number (and carrier in some cases), phone number for a reminder call, IDs for social networks such as Facebook, LinkdIn, Twitter, etc. After entering all the required information, the user can click button 1306 to send the screen contents to the system. In some cases, rather than creating a new calendar system, the calendar may be integrated with one or more of broadly available services, including but not limited to Google Calendar, Yahoo Calendar, Microsoft Live Calendar, etc.

### Strategically Ranking and Allocating Results of Web-Based Inquiries

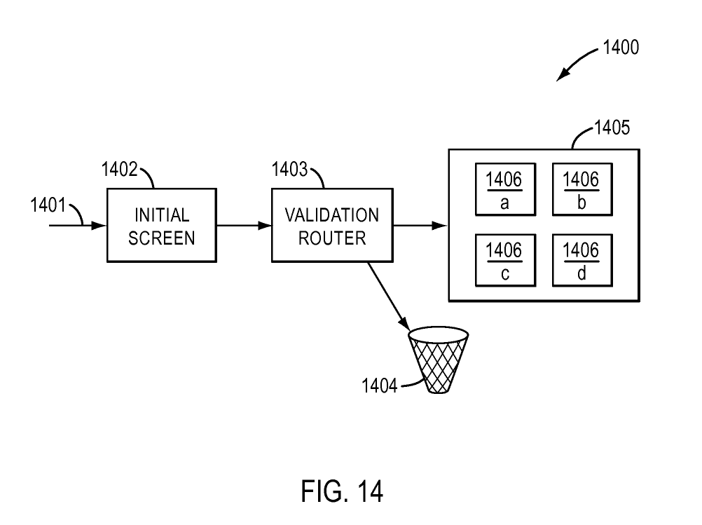

FIG. 14 shows an over view of an exemplary system 1400 for strategically ranking and allocating results of web-based inquiries, according to one aspect of the system and method disclosed herein. Leads come into the system from external lead generation sources, as indicated by arrow 1401, for example, in response to a query from a user, such as a prospective student. Initial screen(s) 1402 collects some common information about an applicant. Applicant information interacts with validation router 1403, as described above and throughout. Bad leads are discarded, as represented by wastebasket 1404; while promising leads move to multiple results screen 1405.

Rather than presenting an applicant with a single result for the “best” school for him, multiple offers are presented, such as, in this example, four results or forms for four schools, although any number may be presented, such as three, or five, or any other suitable number. Each form is branded for the specific school and includes a few additional questions and some information specific to the particular school. The selection of each of those forms, in this example four, depends on different strategies.

Each position 1406a-d in screen 1405 is assigned to a particular strategy, and for the approach of that strategy, the most suitable matching school for the applicant is presented. Typical strategies may include, for example, a for-profit strategy of maximizing benefits for the operator of the service. Other typical strategies may be achieving a certain volume for a client, or giving a partner optimal exposure for a new campaign; or strategic value of the client to the operator.

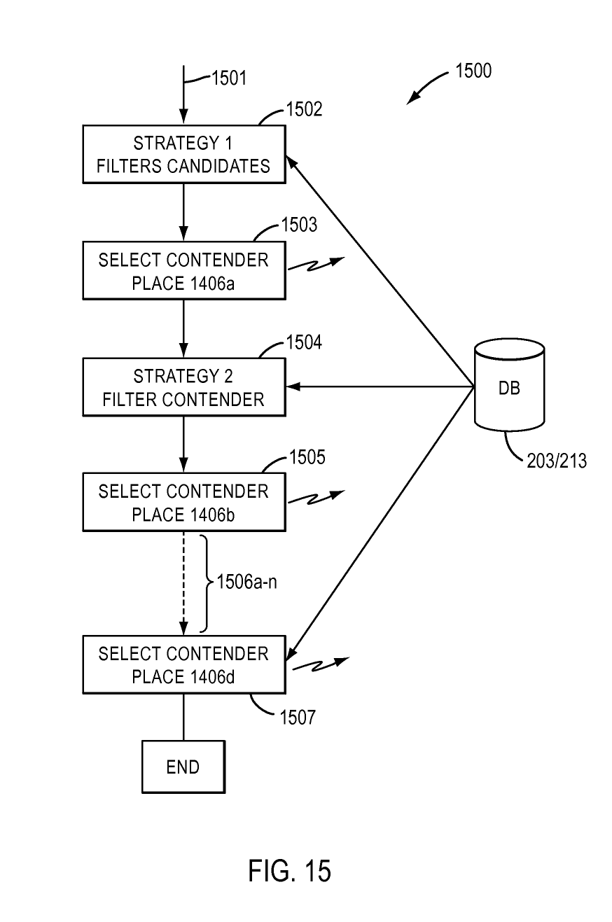

FIG. 15 show an exemplary process 1500 for strategically ranking and allocating results of web-based inquiries according to one aspect of the system and method disclosed herein. Leads come in from the validation router via arrow 1501.

At step 1502, the system filters schools to select the most suitable contender for the applicant, for strategy 1. At step 1503 the form for the selected school is placed in position 1406a in screen 1405 In some cases the client (“school” in this example) does not have additional questions that need to be answered. In these cases, there is simply a “result” displayed here, with the client's brand and other information shown in lieu of a question form.

In step 1504, similarly, a new contender for strategy 2 is selected, and its form is placed in position 1406b in step 1505. This process continues through steps 1506a-n, filtering institutions from data repository 203 or 213 to fill positions 1406c-n (of which positions 1406c and 1406d are shown in FIG. 14), until in step 1507 the last contender is placed in position 1406d. The flash arrows leading from the boxes of steps 1503, 1505, and 1507 indicate information being sent to fill the positions 1406a-d on the web page. The information could be placed by creating a real HTML page, or it could be filled in using scripts that interact with the modules in this process.

Possible strategies may include, but are not limited to, the following, and these strategies can be used alone or in any combination to choose contenders from the respective campaigns:
1. A client is pulled from the top-ranked campaign, with campaigns ranked from highest to lowest price paid per lead.
2. A client is pulled from the top-ranked campaign, with campaigns ranked after discounting price by returned leads.
3. A client is pulled from the top-ranked campaign, with campaigns ranked by closeness to marketing margin.
4. A client is pulled from the top-ranked campaign, with campaigns ranked from most recently activated accounts to oldest active accounts.
5. A client is pulled from the top-ranked campaign, with campaigns ranked from highest to lowest volume.
6. A client is pulled from the top-ranked campaign, with campaigns ranked from highest to lowest open allocation percentage.
7. A client is pulled from the top-ranked campaign, with campaigns ranked from highest to lowest known front-end conversion (enrollment in education programs, valid consumer contact rates, completed application rates for loans, insurance, or a rental, etc).
8. A client is pulled from the top-ranked campaign, with campaigns ranked as above, but for “back-end” conversion metric (graduation in education, close rates for loans or insurance policies, or a completed ‘sale’ where money is received for any products or services to be rendered).
9. A client is pulled from the top-ranked campaign, with campaigns ranked by how closely they fit the consumer's potential needs as expressed by multiple selections of matchable attributes.
10. A client is pulled from the top-ranked campaign, with campaigns ranked by the percentage of recent growth in the account.
11. A client is pulled from the top-ranked campaign, with campaigns ranked by annualized value of the account.
12. A client is pulled from the top-ranked campaign, with campaigns drawn randomly from the list of candidates.
13. A client is pulled from the top-ranked campaign, with campaigns ranked by consumer rating of past performance or experience.
14. A client is pulled from the top-ranked campaign, with campaigns ranked by account brand value.
15. A client is pulled from the top-ranked campaign, with campaigns selected from a list of specific brands.
16. A client is pulled from the top-ranked campaign, with campaigns ranked by distance from consumer.

In various embodiments, other strategies may include maximizing the benefits on the immediate transaction; maximizing the benefits with a partner based on reaching certain number of transactions in a period; meeting volume criteria; meeting best candidate expectations (that is, the absolute best school match for the applicant, not which accrues the most benefits for the operator and others); meeting certain groupings of client attributes.

### Enhanced Automated Call Auditing

In an embodiment, the systems and methods disclosed herein enables verification of compliance by matching every answer by a caller to a query by a call center agent against the information submitted in the school form. The system analyzes calls for various types of noncompliant questions and answers by call center agents (CCAs) during a call, some examples of which are listed here:
1. CCAs are not allowed to talk about financial aid options. They can say that a school adviser can answer questions about financial aid. Agents should never imply or guarantee that a student will receive or be eligible for financial aid, grants or loans
2. CCAs are not allowed to ask hypothetical lead-on questions, such as, for example, “If you were to transfer would you do that within the next six months?”
3. CCAs who do not confirm the school and program submissions to customer.
4. Pushy CCAs insisting that the caller needs to apply for more information.
5. Misleading statements from CCAs, who should never directly or indirectly guarantee employment after graduation; never imply specific job outcome or earnings after completion of degree or program; and never imply or guarantee to certain skills after completion of degree or program nor time it will take to complete a degree or program.
6. CCAs should avoid saying that schools are “fully accredited,” “nationally accredited,” or “regionally accredited.”
7. CCAs should avoid using “school counselor,” instead say “school adviser” or “school representative.”
8. CCAs should avoid using the term “will”, since it implies a guarantee; instead they can say “can” or “may.”
9. CCAs should never use language implying a short-term program or quick entry into the workforce. No one can guarantee the student will interpret this language the way it was delivered.

Commonly, CCAs are required to use a standard script, with some questions required for every call. CCAs perform searches based on the caller's interests. and typically get permission from the caller to submit their information to a specific school and program of interest. Specific schools may have their own set of (additional) questions, such as, for example, the best time to be contacted, that are still expected to be asked by the CCA and answered by the caller. The CCA also typically ask for and/or confirm the caller's personal contact information (first and last name, phone number, address, email address), even if the information is already captured in the system. Every submitted field in the school form should match what the agent is verifying with the caller. By catching agents who submit bad information, the system can quickly notify the call center.

In addition to CCAs, quality assurance representatives (QARs) are occasionally, or in some cases on all calls, listening in into these calls, and QARs can use a monitoring form to evaluate each call. QARs help ensure that CCAs ask all the required questions to ensure the caller is qualified for each school's specific requirements. The QARs then pass along their comments to the agent. In some cases, in addition to QARs and/or in combination with, or in lieu of, automated call quality assurance can be used.

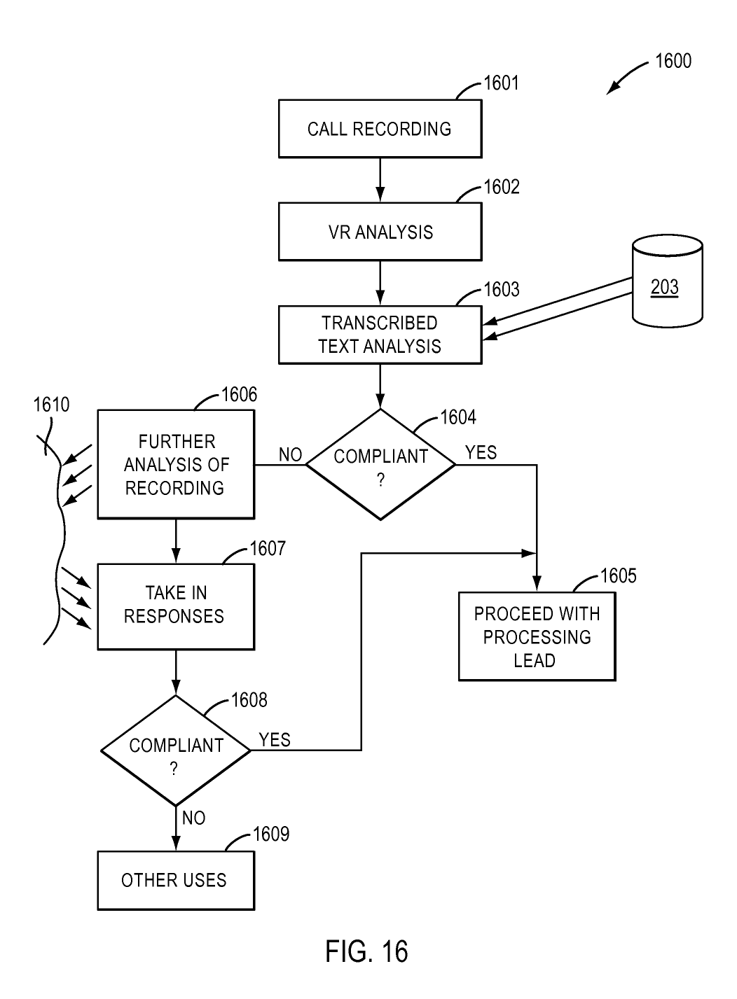

FIG. 16 shows an exemplary process 1600 for treatment of a call from a lead call-in to a call center, according to one aspect of the system and method disclosed herein. In this example, the call has been recorded; however, most of the steps of the process shown in FIG. 16 can be applied in real time to calls, and in such cases, only snippets need be recorded or analyzed. Companies commonly keep recordings of all interactions with customers, and therefore, applying this process to a recording should not impose any particular burden for additional recordings on such companies.

In step 1601 a call to a call center is recorded; and in step 1602 the system executes a voice-recognition analysis of the call and prepares a transcription text of the voice recognition analysis. In step 1603, the transcribed text of the call is analyzed for comparison with compliance rules, the rules being stored, for example, in data repository 203 or in any other, similar storage unit. This analysis may be a simple text analysis, or it may involve use of a rules-and-constraints engine involved, such as ILOG or other commercially available product. In step 1604, the system determines whether or not the call has been conducted in compliance with existing laws and/or school policies.

If the call is compliant (yes), then in step 1605 the system further processes the lead. If the system finds the call is not compliant (no), said finding does not mean the call is actually not in compliance; the problem may simply be that the automated analysis is unclear, and so the process moves to step 1606, where the system sends queries about certain specifics, along with copies of the voice files or voice file snippets, to one to three persons in a processing center 1610 for further analysis.

Center 1610 could be based on the Amazon Mechanical Turk or other, similar technologies or platforms currently available. In step 1607, the system receives the responses from processing center 1610, and in step 1608, the system determines whether the call is compliant, using the data input from center 1610. If the call is now found to be compliant (yes), then in step 1605 the system further processes the lead. If the call is found to be not compliant (no), in step 1609 information derived from the call is discarded and the lead may be processed in other ways.

Different schools have varying types and levels of compliance requirements, so that while a lead may fail to the compliance requirements of one particular school, the same lead may be suitable for some other school that may match the interests of the caller and may have different compliance requirements.

### Enhanced Express and Custom Leads

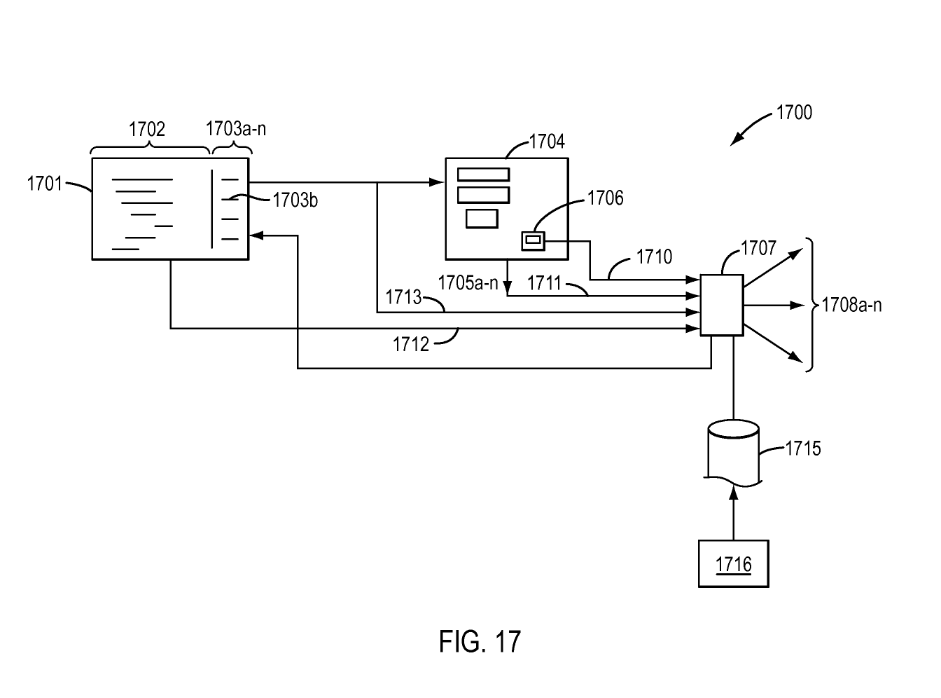

FIG. 17 shows an overview of an exemplary system 1700 for enhanced express and custom leads according to one aspect of the system and method disclosed herein. A marketing partner's page 1701 can generate traffic by use of a search engine that displays search results 1702. Also shown on page 1701 are advertisements 1703a-n. The advertisement 1703b may be an advertisement placed by the system and method disclosed herein. In some cases, the candidate, upon clicking on ad 1703b, may go via arrow 1709 to an intermediate landing page 1704, where the candidate supplies information in information-collection means 1705a-n, which means may include type-in fields, selection lists, or any other, similar means of entering information.

When the candidate supplies the information, he clicks a button 1706 (“Submit,” “Continue,” or other, similar indicator) and continues, via arrow 1710, to invisible page 1707, which loads in the user's browser but does not display on the screen. In an embodiment, the 1707 simply redirects immediately to any one of partner sites 1708a-n, as specified in the routing algorithms. In some cases the “express” delivery does not even use landing page 1704. Instead, a candidate is routed directly from page 1701 via arrow 1713 to page 1707, and then transferred to one of pages 1708a-n, with the routing algorithm basing its decisions on at least some of the keywords of advertisement 1703b alone or of page 1701 as a whole.

Arrow 1714 indicates the mechanism used to dynamically change the ad placement and key words used in the ad as certain quotas of candidates are filled. Additionally, as indicated by arrow 1712, the context of the results displayed on page 1702 may be shown so the system, based on certain keywords that are either white-listed or black-listed by certain partners, may implement additional routing or blocking of a potential candidate from certain sites. Storage 1715 for page 1707 resides on a server (not shown here, but shown throughout), as does software 1716, which operates the redirect algorithms for page 1707.

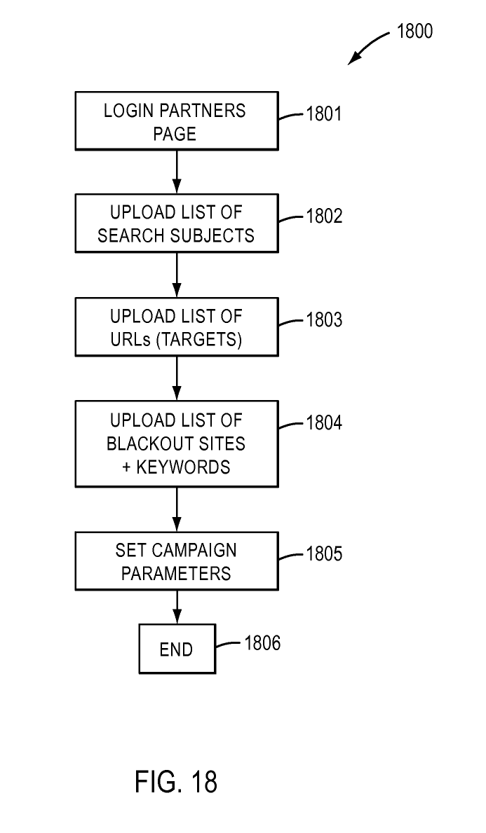

FIG. 18 shows an exemplary process 1800 for partners to enter search requirements for candidates, according to one aspect of the system and method disclosed herein. In an embodiment, in step 1801, a partner can log into a page of a web-based program for setting search criteria. In step 1802 he can upload to the system a list of search subjects or keywords of interest. In step 1803, he can upload to the system a list of target landing pages. For example, a partner may have a school of nursing and a school of engineering.

Depending on the keywords input by the user of the search engine, a user would be directed to different pages, that is, the page for the nursing school or for the engineering school, rather than the generic home page of the whole school. In step 1804, additionally, the partner may upload lists of black-listed sites and key words, to further refine the search results. In step 1805, campaign parameters are set, based on recruiting goals. Principally, in step 1805 the partner specifies the minimum number of “higher demand” candidates he firmly wants, for which he will pay a premium price, and the additional number of “lower demand” candidates he may accept for reduced prices. In step 1806 the process ends.

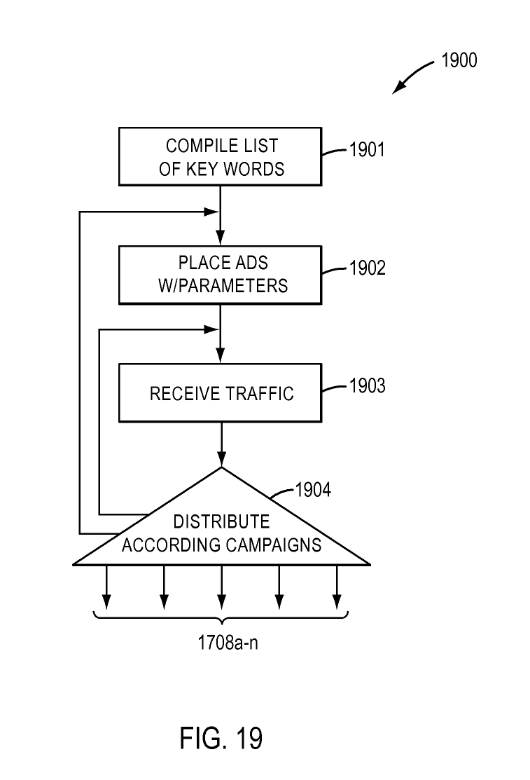

FIG. 19 shows an exemplary process 1900 of the program 716, described in the discussion of FIG. 17, for routing search engine users, according to one aspect of the system and method disclosed herein. In step 1901, the program generates a list of key words that have been input by the process described above, in the discussion of FIG. 18. This list includes all keywords obtained from all campaigns. In step 1902, the system places ads with parameters for key words, such as weight, combination, frequency, as well as black-listing certain words appearing in the results. In step 1903, the system receives traffic via arrows 1710 and 1713, as shown and described in the discussion of FIG. 17. In step 1904 the system directs traffic to partner pages 1708a-n.

At this point, the system may also make various adjustments, such as changing parameters based on the number of candidates already sent to a partner per the campaign parameters set in step 1805 of the process 1800 described in the discussion of FIG. 18. The system may also adjust other parameters as appropriate.

### CONCLUSION

It is clear that many modifications and variations of the system and method disclosed herein may be made by one skilled in the art without departing from the broader spirit and scope of the examples cited here.

For example, the actual configuration and sequence of pages may be somewhat altered without departing from the spirit of the present invention. Further, all web pages may run on one server, or several servers, may be owned by one entity or several entities, or may be “one page” with a sequence of content etc. Also, in some cases, content maybe adapted to the computing device used by the visitor, for example in cases of tablets and in particular mobile devices including but not limited to smart phones, etc. the content may be adapted or reduce in necessary screen size to make it easier to access. These modifications and variations do not depart from its broader spirit and scope, and the examples cited here are to be regarded in an illustrative rather than a restrictive sense.

In some cases, brand information may be stored in an online storage repository in the form of structured data, with the system receiving such data from various sources and organizing and storing it. This data may, in certain cases, be used to compare published electronic documents for compliance, and, if the system finds a discrepancy, it may send an alert electronically and, if non-compliance is found, it may stop the publication of said non-compliant documents.

For example, a system for routing incoming contact leads that may include both personal information as well as answers to specific questions enters the leads into a form on a computer connected to a server running validation routing software, so the lead information is validated based on at least one of several validation services. Further, the system may in some cases limit the number of instances per lead of using external validation services. In some cases, some validations are performed synchronously while information is entered, and/or validation may be performed after the form is submitted as complete.

In some cases, if certain leads are flagged for having certain deficiencies, the leads may be routed to a screen for setting up a follow-up interview, which screen may offer a calendar-type screen for scheduling an appointment. Further, after the appointment is scheduled, the system may send a confirmation to the applicants with a confirmation number, so the applicant could change the appointment at a later time. At the scheduled time, the system may call the applicant, first connecting him to an IVR system for follow-up questions. Upon giving answers, the applicant may be either connected to a live person or offered a selection of pre-recorded information messages.

In alternate embodiments, the present disclosure is implemented in computer hardware, firmware, software, and/or combinations thereof. Apparatus of the present disclosure can be implemented in a computer program product tangibly embodied in a non-transitory computer-readable storage device for execution by a programmable processor; and method steps of the present disclosure can be performed by a programmable processor executing a program of instructions to perform functions of the present disclosure by operating on input data and generating output.

The present disclosure can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language or in assembly or machine language if desired; and in any case, the language can be a compiled or interpreted language. Suitable processors include, by way of example, both general and special purpose microprocessors. Generally, a processor will receive instructions and data from a read-only memory and/or a random access memory.

Generally, a computer will include one or more mass storage devices for storing data files; such devices include magnetic disks, such as internal hard disks and removable disks; magneto-optical disks; and optical disks. Storage devices suitable for tangibly embodying computer program instructions and data (also called the “non-transitory computer-readable storage media”) include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits) and other forms of hardware.

What is claimed is:

1. A method comprising:
receiving, using a computing device, a plurality of compliance rules relating to a first entity;
retrieving, using the computing device, information relating to a web asset of a second entity;
determining, using the computing device, a compliance level of the web asset using the plurality of rules relating to the client and the information relating to a web asset;
adjusting, using the computing device, a trust level of the second entity based on the compliance level, wherein the web asset is blocked from providing leads relating to the first entity where the trust-level falls below a minimum threshold trust level.

2. The method of claim 1 wherein the adjusting comprises a trust level of the web asset based on the compliance level, wherein the web asset is blocked from providing leads relating to the first entity where the trust-level falls of the web asset falls below a minimum threshold trust level.

3. The method of claim 1, wherein the retrieving, determining and adjusting are periodically repeated.

4. The method of claim 1, wherein at least one of the plurality of compliance rules relating to the first entity comprises required content.

5. The method of claim 1, wherein at least one of the plurality of compliance rules relating to the first entity comprises excluded content.

6. The method of claim 1, wherein the web asset is one of: a web page, a web site and an advertisement.

7. The method of claim 1, wherein the retrieving information relating to the web asset of the second entity comprises screen scraping of the web asset.

8. The method of claim 5, wherein the retrieving information relating to the web asset of a second entity additionally comprises performing optical character recognition on the web asset.

9. A method comprising:
receiving, using the computing device, a lead relating to the first entity from a web asset of the second entity;
retrieving, using the computing device, information relating to the web asset of a second entity;
determining, using the computing device, a compliance level of the web asset using the plurality of rules relating to the client;
providing, using the computing device, the lead to the first entity with an indication of the compliance level of the web asset.

10. The method of claim 9 further comprising:
adjusting, using the computing device, a trust level of the second entity based on the compliance level, wherein the web asset is blocked from providing leads relating to the first entity where the trust-level of the second entity falls below a minimum threshold trust level.

11. The method of claim 9 further comprising:
adjusting, using the computing device, a trust level of the web asset based on the compliance level, wherein the web asset is blocked from providing leads relating to the first entity where the trust-level of the web asset falls below a minimum threshold trust level.

12. The method of claim 9, further comprising:
providing, using the computing device, to the second entity, a compliance tracking device, such that the second entity embeds the compliance tracking device in the web asset, such that the compliance tracking device is used to retrieve the information relating to the web asset.

13. The method of claim 9, wherein the information relating to the web asset is the URL of the web asset, the content of the asset and an identification of user the viewing the advertisement.

14. The method of claim 9, wherein at least one of the plurality of compliance rules relating to the first entity comprises excluded content.

15. The method of claim 9, wherein at least one of the plurality of compliance rules relating to the first entity comprises required content.

16. The method of claim 9, wherein the web asset is one of: a web page, a web site and an advertisement.

17. The method of claim 9 further comprising:
charging, using the computing device, the first entity a fee for the lead.

18. The method of claim 15 wherein the fee is based on the compliance level.

19. A non-transitory computer readable storage media storing thereon computer readable instructions that, when executed by a computing device, cause the computing device to:
receiving a lead relating to the first entity from a web asset of the second entity;
retrieving information relating to the web asset of a second entity;
determining a compliance level of the web asset using the plurality of rules relating to the client;
providing the lead to the first entity with an indication of the compliance level of the web asset.

20. A computer system comprising:
at least one processor; and
memory storing instructions configured to instruct the at least one processor to:
receive a lead relating to the first entity from a web asset of the second entity;
retrieve information relating to the web asset of a second entity;
determine a compliance level of the web asset using the plurality of rules relating to the client;
provide the lead to the first entity with an indication of the compliance level of the web asset.
